(19) United States
(12) Patent Application Publication
(10) Pub. No.: US 2024/0290511 A1
(43) Pub. Date: Aug. 29, 2024

(54) METHOD OF STABILIZING A LOWER END OF A THERMAL SHIELD SURROUNDING A CORE BARREL OF A NUCLEAR REACTOR

(71) Applicant: FRAMATOME INC., LYNCHBURG, VA (US)

(72) Inventors: Kenneth Wade Markham, FOREST, VA (US); Timothy M. Wiger, LYNCHBURG, VA (US); Alexander Thomas Bottoms, AMHERST, VA (US)

(21) Appl. No.: 18/584,512

(22) Filed: Feb. 22, 2024

Related U.S. Application Data
(60) Provisional application No. 63/447,777, filed on Feb. 23, 2023.

(51) Int. Cl. G21C 19/20; B23H 9/14; G21C 11/08

(52) U.S. Cl. CPC G21C 19/207; G21C 11/08; B23H 9/14

(57) ABSTRACT

A maintenance method for a nuclear reactor replaces flexible arms of thermal shield flexures with contact bodies. The nuclear reactor has reactor core having a center axis, a core barrel concentric to the center axis a thermal shield arranged around the core barrel and secured to the core barrel and a plurality of thermal shield flexures. Each thermal shield flexure includes a main plate secured to the core barrel and a flexible arm extending from the main plate and welded to a lower edge of the thermal shield. The maintenance method includes installing, at a axial height above the lower edge, a contact body in the thermal shield passing radially, with respect to the center axis, through the thermal shield past an inner circumferential surface of the thermal shield such that a tip of the contact body bears against an outer circumferential surface of the core barrel with a predetermined load allowing the contact body to be slidable against the core barrel axially with respect to the center axis.

The present disclosure relates generally to nuclear reactors and more specifically to devices for stabilizing the lower ends thermal shields in nuclear reactors.

### BACKGROUND

As shown in FIGS. 1a to 1c, a pressurized water nuclear reactor 10 can have nuclear reactor core 12 that is supported in part by a lower core support structure 14 that can include a core barrel 16 concentric to a center axis 18 of the nuclear reactor core 12. The core barrel 16 is a cylindrical shell that contains the fuel assemblies and directs the coolant flow to remove heat generated by the fuel assemblies. A thermal shield 20 can surround the core barrel passive structure to reduce the neutron fluence on the reactor pressure vessel in the region of the reactor core 12. The thermal shield 20 can also reduce thermal shock between a cold leg and the core barrel 16.

A lower edge 22 of the thermal shield 20 can be held in place by a plurality of thermal shield flexures 24. Each thermal shield flexure 24 comprises a main plate 26 secured to the core barrel and a flexible arm 28 extending from the main plate 26 and welded to the lower edge 22 of the thermal shield 20. As installed, flexible arm 28 is fixed to lower edge 22 by a weld 30. As discussed in WO 2021/163211, the flexible arms 28 of these thermal shield flexures 24 are known to fail.

### SUMMARY

A maintenance method for a nuclear reactor is provided for replacing the flexible arms with contact bodies. The nuclear reactor has a reactor core having a center axis, a core barrel concentric to the center axis a thermal shield arranged around the core barrel and secured to the core barrel and a plurality of thermal shield flexures. Each thermal shield flexure includes a main plate secured to the core barrel and a flexible arm extending from the main plate and welded to a lower edge of the thermal shield. The maintenance method includes installing, at a axial height above the lower edge, a contact body in the thermal shield passing radially, with respect to the center axis, through the thermal shield past an inner circumferential surface of the thermal shield such that a tip of the contact body bears against an outer circumferential surface of the core barrel with a predetermined load allowing the contact body to be slidable against the core barrel axially with respect to the center axis.

In examples, the method can further include removing the flexible arm of at least one of the thermal shield flexures, and the contact body is installed as a substitute for the flexible arm.

In examples, the method can further include locking the contact body inside the thermal shield such that the tip of the contact body bears against an outer circumferential surface of the core barrel with the predetermined load allowing the contact body to be slidable against the core barrel axially with respect to the center axis.

In examples, the locking of the contact body inside the thermal shield includes installing a fastener contacting the thermal shield and the contact body.

In examples, the locking of the contact body inside the hole further includes performing a staking to deform the fastener and/or the contact body.

In examples, the performing of the staking deforms threads of the contact body.

In examples, the fastener is a set screw and the installing of the fastener includes screwing the set screw into the thermal shield and into contact with an outer circumferential surface of the contact body.

In examples, the installing of the fastener contacting the thermal shield and the contact body includes machining a hole into the outer circumferential surface of the thermal shield; and introducing the fastener inside the hole

In examples, the method can further include machining a flat surface on the outer circumferential surface of the core barrel, the tip of the contact body including a flat surface, the contact body being installed such that the flat surface of the tip of the contact body contacts the flat surface on the outer circumferential surface of the core barrel.

In examples, an axial height of the flat surface on the outer circumferential surface of the core barrel is greater than an axial height of the flat surface of the tip of the contact body to allow axial sliding of the flat surface of the tip of the contact body along the flat surface on the outer circumferential surface of the core barrel due to differential thermal expansion rates between the core barrel and the thermal shield.

In examples, the machining of the flat surface on the outer circumferential surface of the core barrel includes creating a spotface on the core barrel, the spotface including the flat surface on the outer circumferential surface of the core barrel.

In examples, the spotface and the flat surface of the tip of the contact body each have a circular area, a diameter of the spotface being greater than a diameter of the flat surface of the tip of the contact body to allow axial sliding of the flat surface of the tip of the contact body along the flat surface on the outer circumferential surface of the core barrel due to differential thermal expansion rates between the core barrel and the thermal shield.

In examples, the installing of the contact body includes: piercing a hole passing radially, with respect to the center axis, through the thermal shield from the outer circumferential surface of the thermal shield past to the inner circumferential surface of the thermal shield; and introducing the contact body inside the hole.

In examples, the hole has an internal thread and the contact body has an external thread cooperating with the internal thread, the introducing of the contact body inside the hole including engaging the external thread with the internal thread and screwing the contact body into the hole.

In examples, the piercing of the hole is performed by machining the thermal shield via a machining tool, the method further including: after the piercing of the hole, passing a tip of the machining tool through the hole and machining a flat surface on the outer circumferential surface of the core barrel, the tip of the contact body including a flat surface, the contact body being installed such that the flat surface of the tip of the contact body contacts the flat surface on the outer circumferential surface of the core barrel.

In examples, the machining tool is an electrical discharge machining tool.

In examples, the removing of the flexible arm of at least one of the thermal shield flexures includes leaving the main plate of the at least one thermal shield flexure in place. In examples, the axial height above the lower edge is 6 to 18 inches.

In examples, the removing of the flexible arm of at least one of the thermal shield flexures includes removing the flexible arm of all of the thermal shield flexures; the installing of the contact body including installing, at the axial height above the lower edge, a respective one of the contact body as a substitute for each removed flexible arm.

In examples, the contact bodies are spaced at circumferential intervals about the thermal shield with respect to the center axis.

In examples, the contact body has a diameter of between 2 and 6 inches.

A nuclear reactor is also provided including a reactor core having a center axis, a core barrel concentric to the center axis, a thermal shield arranged around the core barrel and secured to the core barrel, and at an axial height above a lower edge of the thermal shield, a contact body in the thermal shield passing radially, with respect to the center axis, through the thermal shield past an inner circumferential surface of the thermal shield such that a tip of the contact body bears against an outer circumferential surface of the core barrel with a predetermined load allowing the contact body to be slidable against the core barrel axially with respect to the center axis.

In examples, the nuclear reactor further includes at least one partially removed thermal shield flexures, the partially removed thermal shield flexure comprising a main plate having a machined surface indicating that a flexible arm has been removed, the contact body being a substitute for the removed flexible arm.

### BRIEF DESCRIPTION OF THE DRAWINGS

The present invention is described below by reference to the following drawings, in which:

FIG. 1a shows a perspective view of a conventional arrangement of a thermal shield and a core barrel of a nuclear reactor;

FIG. 1b shows a perspective view of a thermal shield flexure;

FIG. 1c shows a cross-sectional circumferentially facing side view of a thermal shield flexure securing a lower edge of the thermal shield to the core barrel;

FIG. 2a shows a cross-sectional circumferentially facing perspective view of a thermal shield flexure securing a lower edge of the thermal shield to the core barrel;

FIG. 2b shows the view of FIG. 2a after the flexible arm has been removed;

FIG. 3a shows the view of FIG. 2b after a hole is pierced into the thermal shield;

FIG. 3b shows the view of FIG. 3a after the hole in the thermal shield is machined to include threads and a spotface is formed on the outer circumferential surface of the core barrel;

FIG. 3c shows the view of FIG. 3b after a contact body is installed in the hole in the thermal shield; and

FIG. 3d shows the view of FIG. 3c after a fastener is installed to lock the contact body in the hole in the thermal shield.

### DETAILED DESCRIPTION

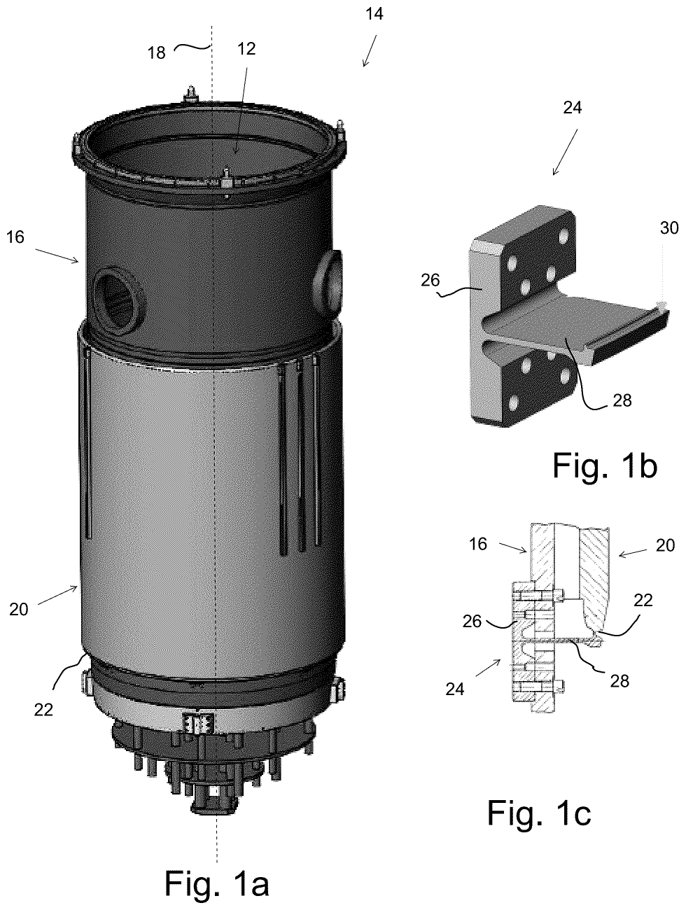

A maintenance method for a nuclear reactor is provided. As shown in FIGS. 1a to 1c and discussed above, the nuclear reactor can be a pressurized water nuclear reactor having nuclear reactor core 12 that is supported in part by a lower core support structure 14 that can include a core barrel 16 concentric to a center axis 18 of the nuclear reactor core 12. The terms axial, radial and circumferential and derivatives thereof as used herein are in reference to center axis 18 unless otherwise specified. The thermal shield 20 can be cylindrical, can be concentric to center axis 18 and can surround the core barrel 16. The lower edge 22 of the thermal shield 20 can be held in place by a plurality of thermal shield flexures 24, each including a main plate 26 secured to the core barrel and a flexible arm 28 extending from the main plate 26 and welded to the lower edge 22 of the thermal shield 20. Thermal shield flexures 24 are spaced at circumferential intervals about the thermal shield 20 with respect to the center axis 18. The circumferential intervals can be unequal. For example, six thermal shield flexures 24 can be spaced at 35, 90, 140, 210, 270, and 330 degrees.

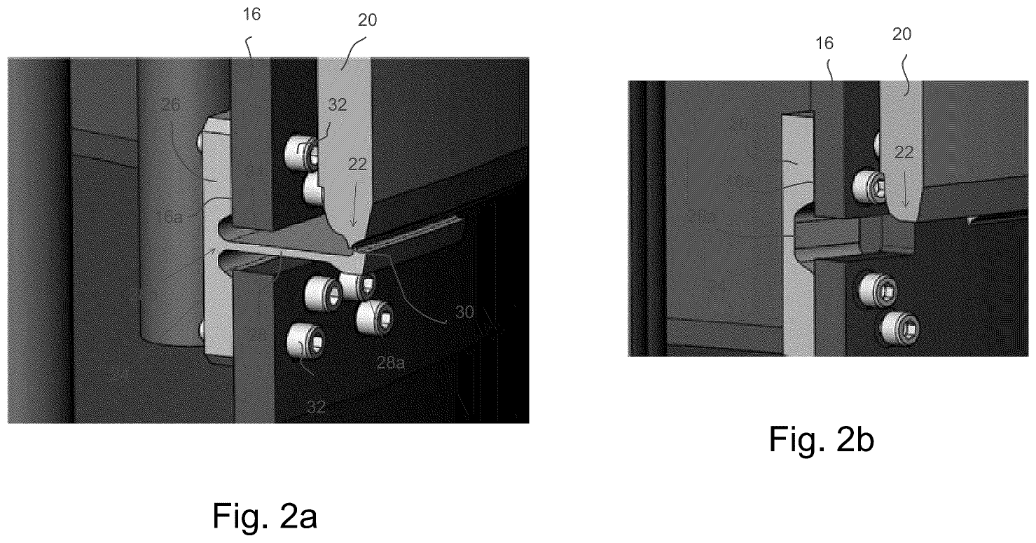

The maintenance method can include removing the flexible arm 28 of at least one of the thermal shield flexure 24, as illustrated by FIGS. 2a and 2b. As shown in FIG. 2a, thermal shield flexure 24 is fixed to an inner circumferential surface 16a of core barrel 16 by bolts 32 passing through main plate 26 and core barrel 16 and pressing main plate 26 against inner circumferential surface 16a. Flexible arm 28 extends radially outward through a corresponding slot 34 formed in core barrel 16. An upper edge of a distal end 28a of the flexible arm 28 is fixed by weld 30 to lower edge 22 of thermal shield 20.

The removing of the flexible arm 28 of at least one of the thermal shield flexure 24 can include machining weld 30 and optionally part of lower edge 22 of thermal shield 20, as well as machining proximal end 28b of flexible arm 28. The machining can be electrical discharge machining (EDM). Thermal shield flexure 24 is shown in FIG. 2b after the removal of flexible arm 28, such that the nuclear reactor includes a partially removed thermal shield flexure comprising the main plate 26 having a machined surface 26a indicating that a flexible arm 28 has been removed. Main plate 26 remains in place fixed to inner circumferential surface 16a of core barrel 16. Alternatively, instead of removing the flexible arm 28, the flexible arm 28 can be left in place.

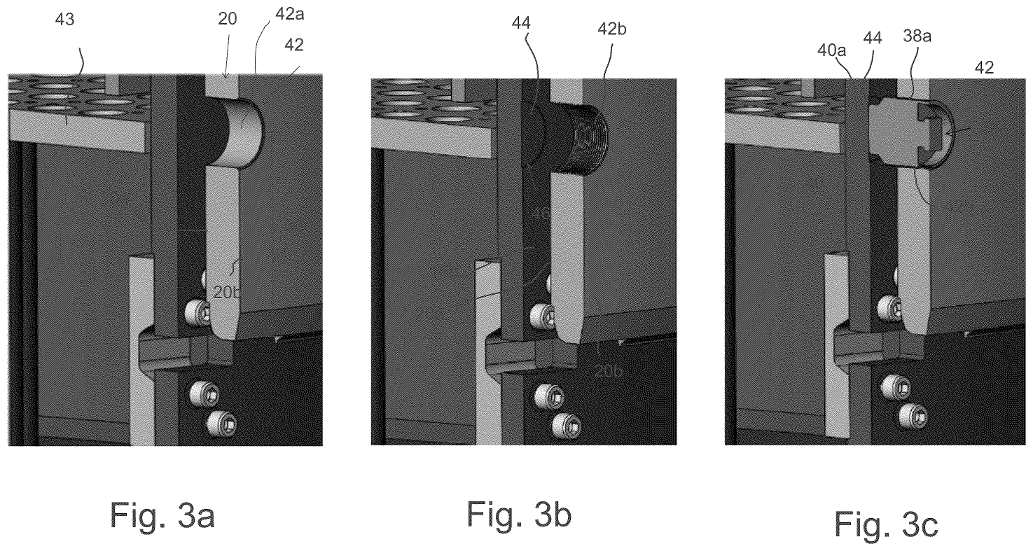

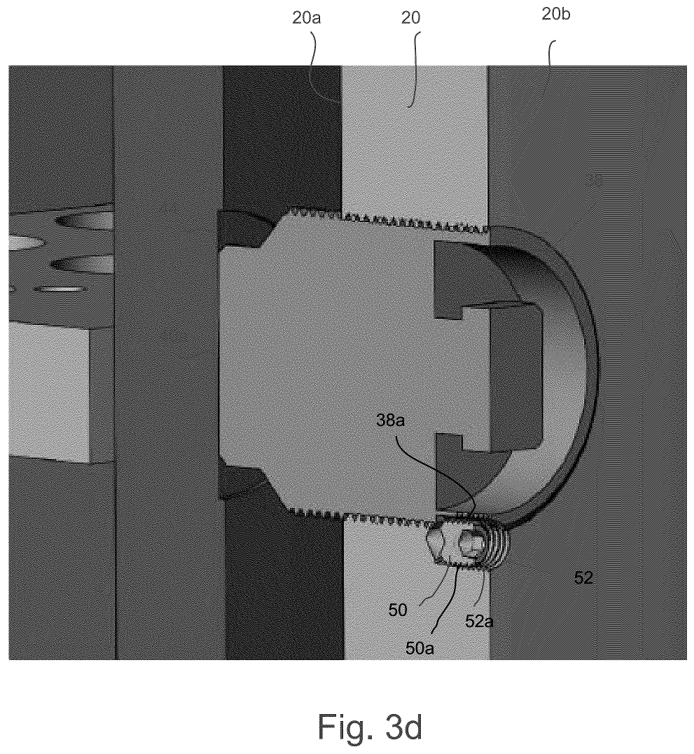

As shown in FIGS. 3a to 3c, prior to or after the removing of flexible arm 28, the method further includes installing, at an axial height 36 above the lower edge 22 and as a substitute for the flexible arm 28, a contact body 38 in the thermal shield 20 that passes radially, with respect to the center axis 18, past an inner circumferential surface 20a of the thermal shield 20 such that a tip 40 of the contact body 38 bears against an outer circumferential surface 16b of the core barrel 16 with a predetermined load allowing the contact body 38 to be slidable against the core barrel 16 axially with respect to the center axis 18. In other words, after contact body 38 is installed in thermal shield 20, tip 40 remains in contact with core barrel 16 as contact body 38 moves upward and downward with respect to core barrel 16. The axial sliding of contact body 38, i.e., the upward and downward movement of contact body 38, is caused by a thermal growth differential of core barrel 16 and thermal shield 20. The axial height 36 above the lower edge 22, which is measured at the center of contact body 38 is in a range of 6 to 18 inches. More specifically, the range is advantageously 9 to 15 inches, or approximately 12 inches (+/−5%). The contact body 38 can be within a circumferential angular range of the removed flexible arm 28 that is five degrees. Advantageously, the contact body 38 is in direct axial alignment with the removed flexible arm 28 and thus the circumferential angular range is zero degrees. This also applies to examples when the flexible arm 28 is left in place, with each contact body 38 being within a five degree circumferential angular range of a respective one of the flexible arms 28.

The installing of contact body 38 in thermal shield 20 can first include, as shown in FIG. 3a, piercing a hole 42 passing radially, with respect to the center axis 18, through the thermal shield 20 from an outer circumferential surface 20b of the thermal shield 20 past to the inner circumferential surface 20a of the thermal shield 20. The hole 42 can be formed by machining, in particular EDM, and can initially have a smooth cylindrical surface 42a, as shown in FIG. 3a. Hole 42 is radially aligned with and at a same axial height as a lowermost core plate 43 fixed inside of core barrel 16. A helical thread 42b can then be machined into surface 42a by EDM, as shown in FIG. 3b. The contact body 38 can have an outer diameter of between 2 and 6 inches, with the outer diameter being defined by the outer edges of thread 38a.

As also shown in FIG. 3b, the method can further include machining a flat surface 44 on the outer circumferential surface 16b of the core barrel 16. Flat surface 44 is radially aligned with and at a same axial height as the lowermost core plate 43. As shown in FIG. 3c, the tip 40 of the contact body 38 includes a flat surface 40a and the contact body 38 is installed such that the flat surface 40a of the tip 40 of the contact body 38 contacts the flat surface 44 on the outer circumferential surface 16b of the core barrel 16. Flat surfaces 40a, 44 distribute the contact area between contact body 38 and core barrel 16 and thereby reduce wear between the two surfaces. In order to allow axial sliding of the flat surface 40a along the flat surface 44 due to differential thermal expansion rates between the core barrel 16 and the thermal shield 20, an axial height of the flat surface 44 is greater than an axial height of the flat surface 40a of the tip 40.

More specifically, the machining of the flat surface 44 on the outer circumferential surface of the core barrel includes creating a spotface 46 on the outer circumferential surface 16b of the core barrel 16 including the flat surface 44. The spotface 46 and the flat surface 40a of the tip 40 each have a circular area. A diameter of the spotface 46 is greater than a diameter of the flat surface 40a of the tip 40 to allow axial sliding of the flat surface 40a of the tip 40 along the flat surface 44 due to differential thermal expansion rates between the core barrel 16 and the thermal shield 20.

The piercing of the hole 42, and the forming of the thread 42b on the surface 42a of hole 42, can thus be performed by machining the thermal shield 20 via a machining tool. After hole 42 is formed, a tip of the machining tool can be passed through the hole 42 and the flat surface 44 can be machined on the outer circumferential surface 16b of the core barrel 16.

More specifically, a first EDM electrode can be used to create hole 42, then a second EDM electrode can be used to form thread 42b and spotface 46. The second EDM electrode first forms thread 42b and then is pressed past inner circumferential surface 20a of thermal shield to create spotface 46. Spotface 46 has approximately (+/−5%) the same outer diameter as internal thread 42b of hole 42.

As shown in FIG. 3c, after the creation of hole 42, contact body 38 can be inserted into hole 42. Contact body 38 has an external thread 38a configured for cooperating with the internal thread 42b of hole 42 and contact body 38 can be screwed into hole 42. More specifically, tip 40 is first inserted into hole 42 from outer circumferential surface 20b of thermal shield 20 and contact body 38 is rotated, for example via a tool such as a wrench or a drill engaging a rear tooling section 48 of contact body 38, until flat surface 40a of tip 40 contacts flat surface 44. Contact body 38 is torqued via rear tooling section 48 to provide a specified preload of contact body 38 onto outer circumferential surface 16b of core barrel 16. Contact body 38 is radially aligned with and at a same axial height as the lowermost core plate 43 such that core plate 43 can provide a radial counterforce for the radial force transmitted to core barrel 16. Contact body 38 is tapered between external thread 38a and tip 40 such that flat surface 40a has a smaller diameter than external thread 38a, which allows flat surface 40a to slide axially along the larger flat surface 44. For example, the axial movement between core barrel 16 and thermal shield 20 is caused by the axial growth of core barrel 16, which causes flat surface 40a of tip 40 of contact body 38 to move upward within spotface 46 along flat surface 44. The radius difference between flat surface 40a and flat surface 44 is sufficient to accommodate a maximum axial travel of flat surface 40a upward within spotface 46. This radius difference can be between ⅛ and ¼ of an inch, and can be set by the radial distance of the tapering between external thread 38a and flat surface 40a.

As shown in FIG. 3d, after contact body 38 is installed in hole 42 and torque to a specified preload, the method can further include locking the contact body 38 inside the thermal shield 20 such that the tip 40 of the contact body 38 bears against the outer circumferential surface 16b of the core barrel 16 with the predetermined load allowing the contact body 38 to be slidable against the core barrel 16 axially with respect to the center axis 18. The locking of the contact body 38 inside the thermal shield 20 can includes installing a fastener 50 contacting the thermal shield 20 and the contact body 38, then performing a staking to deform the fastener 50 and/or the contact body 38. The performing of the staking can involve staking the fastener 50 and the staking can deform threads 50a of the contact body 38.

In the example shown in FIG. 3d, the fastener 50 is a set screw and the installing of the fastener 50 includes screwing the set screw into the thermal shield 20 and into contact with the threaded outer circumferential surface 38a of the contact body 38. The installation of the fastener 50 can include machining a hole 52 into the outer circumferential surface 20b of the thermal shield, and then introducing the fastener 50 inside the hole 52. The hole 52 includes an internal thread 52a configured for cooperating with an external thread 50a of fastener 50, and the introducing of the fastener 50 inside the hole 52 includes engaging the external thread 50a with the internal thread 52a and screwing the fastener 50 into the hole 52.

As noted above, more than one flexible arms 28 of thermal shield flexures 24 can be removed, and a respective one of the contact bodies 38 can be installed, at the axial height 36 above the lower edge 22, as a substitute for each removed flexible arm 28. To completely prevent future issues with thermal shield flexures 24, all of flexible arms 28 can be removed and a respective one of the contact bodies 38 can be installed, at the axial height 36 above the lower edge 22, as a substitute for each removed flexible arm 28 such that the contact bodies 38 are spaced at circumferential intervals about the thermal shield 20 with respect to the center axis 8.

In the preceding specification, the present disclosure has been described with reference to specific exemplary embodiments and examples thereof. It will, however, be evident that various modifications and changes may be made thereto without departing from the broader spirit and scope of present disclosure as set forth in the claims that follow. The specification and drawings are accordingly to be regarded in an illustrative manner rather than a restrictive sense.

What is claimed is:

1. A maintenance method for a nuclear reactor, the nuclear reactor comprising:
a reactor core having a center axis;
a core barrel concentric to the center axis;
a thermal shield arranged around the core barrel and secured to the core barrel;
a plurality of thermal shield flexures, each thermal shield flexure comprising a main plate secured to the core barrel and a flexible arm extending from the main plate and welded to a lower edge of the thermal shield;
the maintenance method comprising:
installing, at a axial height above the lower edge, a contact body in the thermal shield passing radially, with respect to the center axis, through the thermal shield past an inner circumferential surface of the thermal shield such that a tip of the contact body bears against an outer circumferential surface of the core barrel with a predetermined load allowing the contact body to be slidable against the core barrel axially with respect to the center axis.

2. The method as recited in claim 1 further comprising removing the flexible arm of at least one of the thermal shield flexures, the contact body being installed as a substitute for the flexible arm.

3. The method as recited in claim 1 further comprising locking the contact body inside the thermal shield such that the tip of the contact body bears against the outer circumferential surface of the core barrel with the predetermined load allowing the contact body to be slidable against the core barrel axially with respect to the center axis.

4. The method as recited in claim 3 wherein the locking of the contact body inside the thermal shield includes installing a fastener contacting the thermal shield and the contact body.

5. The method as recited in claim 4 wherein the locking of the contact body inside the thermal shield further includes performing a staking to deform the fastener and/or the contact body.

6. The method as recited in claim 5 wherein the performing of the staking deforms threads of the contact body.

7. The method as recited in claim 4 wherein the fastener is a set screw and the installing of the fastener includes screwing the set screw into the thermal shield and into contact with an outer circumferential surface of the contact body.

8. The method as recited in claim 4 wherein the installing of the fastener contacting the thermal shield and the contact body comprising:
machining a hole into the outer circumferential surface of the thermal shield; and
introducing the fastener inside the hole.

9. The method as recited in claim 1 further comprising machining a flat surface on the outer circumferential surface of the core barrel, the tip of the contact body including a flat surface, the contact body being installed such that the flat surface of the tip of the contact body contacts the flat surface on the outer circumferential surface of the core barrel.

10. The method as recited in claim 9 wherein an axial height of the flat surface on the outer circumferential surface of the core barrel is greater than an axial height of the flat surface of the tip of the contact body to allow axial sliding of the flat surface of the tip of the contact body along the flat surface on the outer circumferential surface of the core barrel due to differential thermal expansion rates between the core barrel and the thermal shield.

11. The method as recited in claim 9 wherein the machining of the flat surface on the outer circumferential surface of the core barrel includes creating a spotface on the core barrel, the spotface including the flat surface on the outer circumferential surface of the core barrel.

12. The method as recited in claim 11 wherein the spotface and the flat surface of the tip of the contact body each have a circular area, a diameter of the spotface being greater than a diameter of the flat surface of the tip of the contact body to allow axial sliding of the flat surface of the tip of the contact body along the flat surface on the outer circumferential surface of the core barrel due to differential thermal expansion rates between the core barrel and the thermal shield.

13. The method as recited in claim 1 wherein the installing of the contact body comprising:
piercing a hole passing radially, with respect to the center axis, through the thermal shield from the outer circumferential surface of the thermal shield past to the inner circumferential surface of the thermal shield; and
introducing the contact body inside the hole.

14. The method as recited in claim 13 wherein the hole has an internal thread and the contact body has an external thread cooperating with the internal thread, the introducing of the contact body inside the hole including engaging the external thread with the internal thread and screwing the contact body into the hole.

15. The method as recited in claim 13 wherein the piercing of the hole is performed by machining the thermal shield via a machining tool, the method further comprising:
after the piercing of the hole, passing a tip of the machining tool through the hole and machining a flat surface on the outer circumferential surface of the core barrel, the tip of the contact body including a flat surface, the contact body being installed such that the flat surface of the tip of the contact body contacts the flat surface on the outer circumferential surface of the core barrel.

16. The method as recited in claim 15 wherein the machining tool is an electrical discharge machining tool.

17. The method as recited in claim 2 wherein the removing of the flexible arm of at least one of the thermal shield flexures includes leaving the main plate of the at least one thermal shield flexure in place.

18. The method as recited in claim 1 wherein the axial height above the lower edge is 6 to 18 inches.

19. The method as recited in claim 2 wherein the removing the flexible arm of at least one of the thermal shield flexures includes removing the flexible arm of all of the thermal shield flexures;
the installing the contact body including installing, at the axial height above the lower edge, a respective one of the contact body as a substitute for each removed flexible arm.

20. The method as recited in claim 19 wherein the contact bodies are spaced at circumferential intervals about the thermal shield with respect to the center axis.

21. A nuclear reactor comprising:
a reactor core having a center axis;
a core barrel concentric to the center axis;
a thermal shield arranged around the core barrel and secured to the core barrel; and
at an axial height above a lower edge of the thermal shield, a contact body in the thermal shield passing radially, with respect to the center axis, through the thermal shield past an inner circumferential surface of the thermal shield such that a tip of the contact body bears against an outer circumferential surface of the core barrel with a predetermined load allowing the contact body to be slidable against the core barrel axially with respect to the center axis.

22. The nuclear reactor as recited in claim 21 further comprising at least one partially removed thermal shield flexure, the partially removed thermal shield flexure comprising a main plate having a machined surface indicating that a flexible arm has been removed, the contact body being a substitute for the removed flexible arm.
